(19) United States
(12) Patent Application Publication
(10) Pub. No.: US 2024/0288179 A1
(43) Pub. Date: Aug. 29, 2024

(54) ACQUIRING A USER CONSUMPTION PATTERN OF DOMESTIC HOT WATER AND CONTROLLING DOMESTIC HOT WATER PRODUCTION BASED THEREON

(71) Applicants: DAIKIN INDUSTRIES, LTD., Osaka-shi, Osaka (JP); DAIKIN EUROPE N.V, Oostende (BE)

(72) Inventors: Mehran ZAREH ESHGHDOUST, Oostende (BE); Kristof VANDEMERGEL, Oostende (BE); Matteo PAOLELLA, Oostende (BE)

(21) Appl. No.: 18/571,694

(22) PCT Filed: Jun. 21, 2022
(86) PCT No.: PCT/JP2022/024684

§ 371 Date: Dec. 18, 2023

(30) Foreign Application Priority Data
Jun. 22, 2021 (EP) 21180966.0

(51) Int. Cl. F24D 19/10; G06Q 10/109

(52) U.S. Cl. CPC F24D 19/1063; G06Q 10/109

(57) ABSTRACT

A computer-implemented method acquires a user consumption pattern of domestic hot water. The method includes acquiring data representing an amount of equivalent energy tapped from a heat storage tank within a first time period, generating a first history or data collection of data representing an amount of cumulative heat tapped from the heat storage tank over a number of first time periods, and acquiring a user consumption pattern of domestic hot water by applying a user-consumption-pattern-determination-algorithm to the generated first history or data collection of data representing amount of cumulative heat tapped from the heat storage tank. The heat storage tank is a pressurized tank. The user-consumption-pattern-determination-algorithm is a time-series-forecast-algorithm trained on history or data collection representing amount of cumulative heat tapped from the heat storage tank or equivalent heat storage tanks, and defining user consumption patterns in one or more machine-learning-algorithms.

### TECHNICAL FIELD

The present disclosure relates to a computer-implemented method of acquiring a user consumption pattern of domestic hot water, a computer-implemented method of generating a domestic hot water consumption forecast and a computer-implemented method of controlling domestic hot water production and/or distribution. Moreover, the disclosure relates to a related controller for generating a domestic hot water consumption forecast, a controller for controlling domestic hot water production and/or distribution and a system for producing and/or distribution domestic hot water. In addition, the disclosure relates to a corresponding computer program and a computer-readable medium having stored thereon said computer program.

### BACKGROUND ART

In recent years buildings like homes or office spaces have been equipped with smart home networks to provide automated control of devices, appliances and systems, such as heating, ventilation, and air conditioning (“HVAC”) system, lighting systems, alarm systems, home theatre and entertainment systems. Smart home networks may include control panels that a person may use to input settings, preferences, and scheduling information that the smart home network uses to provide automated control the various devices, appliances and systems in the building. For example, a person may input a desired temperature and a schedule indicating when the person is away from home. The home automation system uses this information to control the HVAC system to heat or cool the home to the desired temperature when the person is home, and to conserve energy by turning off power-consuming components of the HVAC system when the person is away from the home or for example sleeping.

Similar ideas exist in the field of domestic hot water production or distribution. The heating demand in domestic environments is made up of two main sources: sanitary hot water production and space heating. Sanitary hot water is typically produced either on-demand (requiring a relatively high-power device such as a gas boiler) or using a buffered approach with a hot water tank, which can be heated from a variety of sources, such as electric, solar, gas and heat pump. The demand for space heating of housing reduces in absolute values, thanks to the improved insulations (e.g. passive housing) and smaller houses. On the other hand, the demand for domestic hot water remains and even slightly increases. Hence, sanitary hot water production has a larger relative share in the total domestic heating demand.

In case of systems with a hot water storage tank, in order to provide the user with sufficient hot water, usually a fixed minimum temperature of the tank is set throughout the day, where the desired minimum temperature is chosen at the safe side. For energy saving reasons, newer systems use a fixed pattern through a weekly schedule. For example, the minimum temperature of the tank is lowered through the night or in the morning, when higher demand is expected, the temperature of the tank is increased.

In order to further improve energy efficiency of domestic hot water systems using a hot water storage tank, it is necessary to provide such systems for producing and/or distributing domestic hot water with means to more accurately predict the actual consumption of domestic hot water, thereby allowing the system to reduce the in the heat storage tank stored heat or hot water (hot water held in reserve) to a minimum, while maintaining user comfort. In order to provide the system with such a means for more accurately predicting the consumption of domestic hot water, it is also necessary to provide the system with means for more accurately estimating the available usable hot water content of the tank. This is generally done by detecting and measuring the use of domestic hot water. Known systems use for this purpose a monitoring system including a flow meter and a temperature sensor. Based on the outputs of these units the system estimates the energy which is thought to be taken out of the hot water storage tank and estimates the remaining usable hot water content of the tank.

US 2015/0226460 A1 for example describes a retrofit water boiler monitoring and forecast system, method and computer program product, for a water boiler system which includes a water boiler, a cold-water pipe, a hot-water pipe, including: an intake temperature sensor, configured to measure a water temperature in the cold-water intake pipe; a flow meter, configured to measure a flow rate of water running through the water boil system; an outlet temperature sensor, configured to measure a water temperature in the hot-water outlet pipe; a processing unit, adapted to receive sensor date from the intake temperature sensor, flow meter, and outlet temperature sensor, and configured to calculate an amount of available hot water in the water boiler based on the sensor data; and a display panel coupled to the processing unit configured to display at least one estimated real-time usage value, calculated by the processing unit based on the amount of available hot water.

### SUMMARY OF INVENTION

In view of the above, it would be desirable to provide a computer-implemented method of acquiring a user consumption pattern of domestic hot water, a computer-implemented method of generating a domestic hot water consumption forecast, a computer-implemented method of controlling domestic hot water production and/or distribution, a controller for generating a domestic hot water consumption forecast, a controller for controlling domestic hot water production and/or distribution, a system for producing and/or distribution domestic hot water, a computer program and a computer-readable medium having stored thereon said computer program, allowing a more accurate generation or determination of a domestic hot water consumption forecast or prediction, thus, improving energy efficiency and reducing environmental footprint of domestic hot water production and/or distribution. A further object is to allow a smart control of the domestic hot water production and/or distribution by adapting the water heating process to individual usage conditions with the aim of reducing energy consumption while maintaining user comfort.

This may be achieved by a computer-implemented method of acquiring a user consumption pattern as defined in claim 1, a computer-implemented method of generating a domestic hot water consumption forecast as defined in claim 12, a computer-implemented method of controlling domestic hot water production and/or distribution as defined in claim 17, a controller for generating a domestic hot water consumption forecast as defined in claim 21, a controller for controlling domestic hot water production and/or distribution as defined in claim 22, a system for producing and/or distributing domestic hot water as defined in claim 23, a computer program as defined in claim 25 and a computer-readable medium as defined in claim 26. Embodiments may be found in the dependent claims, the following description and the accompanying drawings.

The present disclosure provides a user-consumption-pattern-determination algorithm that is trained on a history or data collection representing amount of heat taped from a heat storage tank and/or histories or data collections representing amount of heat taped from a heat storage tank or normalized heat storage tanks.

In this way it becomes possible to more accurate determine a user-consumption-pattern, in particular of an individual user or individual household, by using a trained algorithm which can draw on data or empirical values collected from a large number of users over a long period of time.

According to one embodiment of the present disclosure, a computer-implemented method of acquiring a user consumption pattern of domestic hot water is provided. The computer-implemented method includes:
acquiring data representing an amount of heat, in particular an amount of equivalent energy, tapped from a heat storage tank, in particular a pressurized tank, within a preferably predetermined first time period,
generating a first history or data collection of data representing amount of heat, in particular cumulative heat, tapped from the heat storage tank over a preferably predetermined number of first time periods, and
acquiring a user consumption pattern of domestic hot water by applying a user-consumption-pattern-determination-algorithm to the generated first history or data collection of data representing amount of heat tapped from the heat storage tank, wherein the user-consumption-pattern-determination-algorithm is an algorithm, in particular a time-series-forecast-algorithm, trained on history(ies) or data collection(s) representing amount of heat tapped from the heat storage tank or normalized heat storage tanks and defining user consumption patterns of domestic hot water using one or more machine-learning-algorithms.

In the context of the present disclosure, the term “acquiring” with regard to the acquisition or collection of data representing the amount of heat tapped from the heat storage tank is to be understood such that the respective data may be determined by using sensors such as temperature sensors or flow meters or by accessing or reading data representing the amount of heat tapped from the heat storage tank recorded in a memory. The memory may store periodic temperature and flow rate measurements of heat or domestic hot water stored in a heat storage tank for a certain time period.

In addition, in the context of the present disclosure, the term “representing” with regard to acquisition of data is to be understood such that the system and/or computer-implemented method may determine or reconstruct from the acquired data a specific amount of heat stored in the heat storage tank at a specific time and/or a specific time period.

Moreover, in the context of the present disclosure, the term “amount of heat” with regard to the tapping from the heat storage tank or with regard to the amount of heat stored in the heat storage tank (discussed later) is used to define the energy which is e.g. contained in the water tapped from the heat storage tank. In other words, the heat or energy drawn from the heat storage tank during a tapping (draw-off). Accordingly, with regard to the heat stored in the heat storage tank, the term “heat” refers for example to the remaining equivalent hot water (EHW) at t₀.

The term “equivalent hot water (EHW)” corresponds to the maximum hot water volume “V₄₀” as defined in EN16147. According to EN16147, the maximum amount of mixed water at 40° C. in one single draw-off (from a specific heat storage tank) shall be determined by calculating the hot water energy during the draw-off. The hot water flow rate fₘₐₓ together with the temperatures of the incoming cold water θ_{WC} and the outgoing hot water θ_{WH} are measured during the draw-off at least each 10 s. The maximum hot water volume V40 is calculated using following formula:

$${V}_{40} = \frac{1}{( 40 - 10 ) \times 60} {\int }_{0}^{{{t}_{40}}_{}} {f}_{max} ( t ) \times [ {θ}_{WH} ( t ) - {θ}_{WC} ( t ) ] dt$$

where:
V₄₀ is the maximum volume of mixed water at 40° C. in 1;
θ_{WH}(t)-θ_{WC}(t) is the temperature difference between hot water temperature at outlet and cold water at inlet of domestic hot water storage in K;
t₄₀ is the time from starting the draw-off until θ_{WH}(t) is less than 40° C. in s;
fₘₐₓ(t) is the flow rate of hot water during draw-off in l/min.

In addition, in the context of the present disclosure, the term “equivalent energy” (also called “useable energy”) with regard to the tapping from the heat storage tank is to be understood as the amount of water at 40° C. in litters which contains the water's thermal energy with respect to 10 degrees. Namely, for a volume V [litters] at temperature T[° C.] we get:

$$E {V}_{40} ( t ) = \frac{ρ {C}_{p} V ( T - 10 )}{ρ {C}_{p} ( 40 - 10 )} = \frac{V ( T - 10 )}{30} ,$$

Furthermore, the term “user consumption pattern (UCP)” defines in the present disclosure parameters like temperature and/or amount of hot water tapped from the heat storage tank indicating the amount of heat tapped from the heat storage tank, in particular an cumulative amount of heat, at periodic intervals of time or within a certain time period. For example, does a user take shower every morning around 7 am, the user consumption pattern will show an increased demand on domestic hot water in a time period starting at 6 am and ending at 8 am.

Yet, in the context of the present disclosure, the term “predetermined” with respect to “time period” or “number of first time periods” is to be understood such as at a certain point in time, for example an initial point (initialization) when the computer-implemented method or the user-consumption-pattern-determination-algorithm is started or an update point (updating of the algorithm) when e.g. the user-consumption-pattern-determination-algorithm is updated, the respective “time period” or “number of first time periods” is manually or automatically determined, in case of automatically, the value is determined by the relevant algorithm, respectively.

Hence, at the time the computer-implemented method of acquiring a user consumption pattern or the user-consumption-pattern-determination-algorithm is started, the first time period may be set to one hour and the number of first time periods may be set to 12, thereby defining a prediction horizon of 12 hours. In other words, the first history or data collection of data representing amount of heat will span over 12 hours. In a next step, for example after 12 hours, or at a certain hour of the day, for example midnight or midday, the user-consumption-pattern-determination-algorithm may be updated based on the generated first history or data collection, thereby, the first time period for optimization reasons may be changed or set to 4 hours and the number of first time periods may be set to 6, thereby defining a new prediction horizon of 24 hours, wherein the first prediction horizon and the new prediction horizon may be combined to a cumulated prediction horizon of 36 hours.

In addition, in the context of the present disclosure, the term “normalized” with regard to the heat storage tanks is to be understood such that the respective heat storage tank or tanks in its/their characteristic(s) correspond(s) to the one heat storage tank for which the computer-implemented method of acquiring a user consumption pattern of domestic hot water is used or applied. In other words, the characteristic(s) of the heat storage tanks on which the algorithm was trained should not deviate so much from the characteristic of the actual heat storage tank that a negative effect on the acquisition or determination of the user consumption pattern of domestic hot water is to be expected. Accordingly, the used heat storage tank should be similar to the one on which the algorithm was trained. Alternatively, the algorithm may be trained for compensating such deviations (e.g. automatically scaling the size of the used heat storage tank to the one on which the algorithm was trained. On the other hand, the algorithm may also be trained on different sizes or types of heat storage tanks, so that the algorithm is able to adjust accordingly).

According to a further embodiment of the present disclosure, the computer-implemented method may further include:
generating a second history or data collection of data representing amount of heat tapped from the heat storage tank over a preferably predetermined number of first histories or data collections, wherein the first history or data collection preferably extends over a time period of one day or 24 hours and the second history or data collection preferably extends over a time period of one week or 7 days or 168 hours.

As noted above, the first time period in connection with the number of first time periods defines the prediction horizon, the same holds true for the second time period (number of first histories). Accordingly, the first and second history can also be seen as one history or data collection, spanning over (number of first periods×first time period)×number of first historics.

Additionally, in some embodiments of the present disclosure, the preferably predetermined first time period may extend or span over one week, two days, one day, 12 hours, 8 hours, 6 hours, 4 hours, 1 hour, 30 minutes, 10 minutes or 1 minute, and/or the preferably predetermined number of first time periods of the first history or data collection is 1, 2, 3, 4, 6, 24, 48, 144 or 1440.

Moreover, in some embodiments the preferably predetermined first time period may be determined based on the length/duration of the first history or amount of data of the data collection, in particular at an initial point and/or updating point. In other words, as described before, the prediction horizon may be changed, once more data representing amount of heat tapped from the heat storage tank over the prediction horizon are available.

According to a further embodiment of the present disclosure, when at the initial point (initiation of the computer-implemented method or user-consumption-pattern-determination-algorithm) no first history or data collection or only a short first history or view data of the data collection is/are available, a data filler is used to feed the user-consumption-pattern-determination-algorithm.

Moreover, in some embodiments, after a preferably predetermined fifth time period (second to third time period will follow later) the user-consumption-pattern-determination-algorithm may be newly initiated/started or updated or the initial point is newly set.

According to a further embodiment (general ML model) of the present disclosure, the consumption-pattern-determination-algorithm may be trained on:
history data or data collection(s) representing amount of heat tapped from the heat storage tank or normalized heat storage tanks by a plurality of users or households over a preferably predetermined second time period (training horizon), and hour of day, in particular of the respective first time period, in particular within the respective history or data collection of data representing amount of heat tapped from the heat storage tank or normalized heat storage tanks.

Moreover, in an alternative embodiment (personalized model), the consumption-pattern-determination-algorithm may be trained on:
history data or data collection(s) representing amount of heat tapped from the heat storage tank by a user, in particular an individual user, or a household, in particular an individual household, over a preferably predetermined second time period, and hour of day, in particular of the respective first time period, in particular within the respective history or data collection of data representing amount of heat tapped from the heat storage tank.

In a further embodiment of the present disclosure, the preferably predetermined second time period extends or spans over 30 days, 60 days, 90 days, 180 days, one year or two years.

Additionally, in some embodiments, the the consumption-pattern-determination-algorithm may be further or alternatively be trained on:
day of week, in particular of the respective first time period and/or of the respective history or data collection of data representing amount of heat tapped, and/or
day of the year and/or week of the year and/or month of the year, in particular of the respective first time period and/or the respective history data or data collection, and/or
weather condition, in particular at the respective first time period and/or of the respective history or data collection of data representing amount of heat tapped, and/or
outside temperature, in particular at the respective first time period and/or of the respective history or data collection of data representing amount of heat tapped, and/or
vacation situation of the user or the household, in particular at the respective first time period and/or of the respective history or data collection of data representing amount of heat tapped, and/or
   energy price, in particular at the respective first time period and/or of the respective history or data collection of data representing amount of heat tapped, and/or
   green energy availability, in particular at the respective first time period and/or of the respective history or data collection of data representing amount of heat tapped, and/or
   geographical location, in particular at the respective first time period and/or of the respective history or data collection of data representing amount of heat tapped, and/or
   cultural factors, in particular at the respective first time period and/or of the respective history or data collection of data representing amount of heat tapped.

In the context of the present invention, the term “green energy availability” with regard to the teaching of the algorithm is to be understood such that for example on a sunny day, when a lot of preferably local photovoltaic electricity is available, in particular during the winter season, the trained or thrifty user may tend to take a bath. The same may apply for times when the price for electricity/energy is low.

On the other hand, the “geographical location” and/or “cultural factors” may as well influence users' domestic hot water consumption habits. For example, users living in areas close to the equator may shower more frequently than users in cooler areas. Moreover, because of “cultural factors” like religion or wealth, users also may tend to take a bath more frequently. The same may apply to the amount of hot water used for one shower or one bath.

According to a further embodiment of the present disclosure, the user-consumption-pattern-determination-algorithm may also or additionally consider meta data when determining the user consumption pattern (UCP), where the meta data are preferably selected from the group comprising: number of residents (living in the respective household), age(s) of the resident(s), average age of residents, gender of the resident(s), geographical location, cultural factors, which may be automatically determined based on the geographical location, annual hot water consumption.

Moreover, in some embodiments, the user-consumption-pattern-determination-algorithm may further comprise:
assigning the user or household to a predetermined cluster or group based on at least one of the meta data,
determining a user-consumption-pattern-determination-sub-algorithm based on the assigned cluster or group,
wherein the user-consumption-pattern-determination-sub-algorithm was preferably trained on the data of a plurality of users or households having the same at least one of the meta data.

In a further embodiment of the present disclosure, after a user-consumption-pattern-determination-sub-algorithm may be determined, an individual-user-consumption-pattern-determination-algorithm is developed by training the pre-set user-consumption-pattern-determination-sub-algorithm based on acquired first history data or data collection(s) and/or second history data or data collection(s) representing amount of heat tapped from the heat storage tank by the preferably individual user or the preferably individual household over a preferably predetermined third time period, wherein the preferably predetermined third timer period preferably extends over 1 day, 2 days, 10 days, 30 days, 60 days, 90 days, 180 days, one year or continuously.

According to a further embodiment of the present disclosure, the user-consumption-pattern-determination-algorithm may be trained to determine habits of individual users including: taking shower in the morning, taking shower in the evening, taking bath in the evening, using an average amount of heat, in particular an amount of equivalent energy, for taking a shower or a bath.

Additionally, the present disclosure is directed to a computer-implemented method of generating a domestic hot water consumption forecast, the method including: acquiring a user consumption pattern (UCP) of domestic hot water by using the above described computer-implemented method of acquiring a user consumption pattern of domestic hot water, and generating the domestic hot water consumption forecast by applying a domestic-hot-water-consumption-forecast-algorithm to the acquired user consumption pattern (UCP).

Moreover, in some embodiments of the present disclosure, the domestic-hot-water-consumption-forecast-algorithm may consider detected deviations when generating the domestic hot water consumption forecast, wherein the deviations preferably comprise: vacation situation of the user or the household, weather condition, unexpected events like earlier shower than average, guest(s), party, etc.

According to a further embodiment of the present disclosure, in the event of a detection of a deviation, the domestic hot water consumption forecast is automatically adjusted and/or the user is required to confirm the detected deviation, preferably via a control terminal, preferably a remote control terminal or a voice recognition system, and depending on the confirmation and/or input of the user the domestic hot water consumption forecast may be adjusted.

Furthermore, in some embodiments, the domestic hot water consumption forecast may be determined for a fourth preferably predetermined time period (control horizon) of 10 minutes, 30 minutes, 1 hour, 2 hours, 4 hours, 6 hours or 12 hours.

Moreover, the disclosure provides a computer-implemented method of controlling domestic hot water production and/or distribution, particularly by controlling a system for producing and/or distributing domestic hot water, the method comprising: generating a domestic hot water consumption forecast by using the above described computer-implemented method of generating a domestic hot water consumption forecast, and controlling domestic hot water production and/or distribution based on the generated domestic hot water consumption forecast.

In the present disclosure, the term “controlling” concerning the “controlling domestic hot water production and/or distribution” defines that for example based on detected temperatures or detected flow rates and/or based on estimated values or patterns, like a temperature distribution pattern or a user consumption pattern or a user consumption forecast the production of domestic hot water is changed, for example increased or decreased by starting or stopping heating of the stored hot water by the loading coil.

Furthermore, the term “production” concerning the “controlling of domestic hot water production and/or distribution” defines in the present disclosure the production of hot water, meaning the increase of the temperature above approximately 40° C. In more detail, in order to produce a certain amount of heat or domestic hot water, the loading coil is provided with a hot fluid, which is for example heated and provided by a heat pump. By heat transfer between the fluid flowing through the loading coil and hot water stored in the hot water storage tank, the hot water stored in the tank is heated, meaning the temperature of the hot water is increased.

Yet, in the present disclosure the term “distribution” defines the distribution or making available (providing) of heat or hot water, particularly water with a temperature above 40° C., to respective users, like a shower or a bathroom.

In addition, in a further embodiment of the present disclosure, the amount of heat, in particular amount of equivalent energy, to be stored in the heat storage tank may be determined based on the generated domestic hot water consumption forecast.

According to another embodiment of the present disclosure, the amount of heat, in particular amount of equivalent energy, to be stored in the heat storage tank may be determined based on the generated domestic hot water consumption forecast.

Moreover, in some embodiments, the amount of heat, in particular amount of equivalent hot energy, to be stored in the heat storage tank, may be determined by applying a heat-control-algorithm to the generated domestic hot water consumption forecast, wherein the heat-control-algorithm is preferably a trained algorithm.

Furthermore, in some embodiments of the present disclosure, the heat-control-algorithm may be trained on: electric energy price (e.g. night and day difference, high availability of green energy like photovoltaic or wind electricity), local or green energy availability, weather condition, weather forecast, etc.

According to some embodiments of the present disclosure, dependent on electric energy price, local or green energy availability, weather condition and/or weather forecast, the heat-control-algorithm may initiate or start production of heat or increase the amount of heat stored in the heat storage tank, even though the generated domestic hot water consumption forecast does not require an increase of stored heat.

In addition, the present disclosure provides a controller for generating a domestic hot water consumption forecast having a control unit and means adapted to execute the steps of the above described computer-implemented method of generating a domestic hot water consumption forecast.

Furthermore, the present disclosure is directed to a controller for controlling domestic hot water production and/or distribution, particularly by controlling a system for producing and/or distributing domestic hot water, having a control unit and means adapted to execute the steps of the above described computer-implemented method of controlling domestic hot water production and/or distribution.

The present disclosure further provides a system for producing and/or distributing domestic hot water, including: a controller, in particular the above described controller for generating a domestic hot water consumption forecast, and means adapted to execute the steps of the above described method of controlling domestic hot water production and/or distribution.

In some embodiments of the present disclosure, the system for producing and/or distributing domestic hot water may further include:
a heat storage tank, particularly a hot water storage tank, more particularly a pressurized tank, and
means adapted to determine an amount of heat, in particular an amount of equivalent energy, stored in the heat storage tank and/or to determine an amount of heat, in particular an amount of equivalent energy, tapped from the heat storage tank.

Since the controller and the system are adapted to execute the above described steps of the computer-implemented methods, the further features disclosed in connection with the computer-implemented methods may also be applied to the controller and the system. The same applies vice versa for the computer-implemented methods.

The disclosure further provides a computer program comprising instructions to cause the above described system for producing and/or distributing domestic hot water and/or the above described controller for controlling domestic hot water production to execute the steps of the above described computer-implemented method of controlling domestic hot water production and/or distribution and/or the above described controller for generating a domestic hot water consumption forecast to execute the steps of the above described computer-implemented method of acquiring a user consumption pattern of domestic hot water.

Moreover, the present disclosure provides a computer-readable medium having stored thereon the above described computer program.

In this regard, the above described computer-implemented method cannot only be performed by the controller and the system which are adapted to execute the described steps of the computer-implemented method, the method can also be performed by cloud-computation. Meaning, the acquired data representing an amount of heat tapped from a specific heat storage tank, in particular the data of the real temperature sensors of the heat storage tank, are sent to the cloud, the cloud is adapted to execute the above described steps of the computer-implemented method of acquiring a user consumption pattern and sends back the acquired user consumption pattern of domestic hot water to the controller for generating a domestic hot water consumption forecast by executing the above described steps of the method of generating a domestic hot water consumption forecast.

Moreover, since the computer program and the computer-readable medium are also related to the above described controller and system for generating a domestic hot water consumption forecast and/or for controlling domestic hot water production and/or distribution, the further features disclosed in connection with the computer-implemented methods, the controller and the system may also be applied to the computer program and the computer-readable medium and vice versa.

According to a first aspect of present disclosure, a computer-implemented method of monitoring and/or controlling domestic hot water production and/or distribution, particularly by controlling a system for domestic hot water production and/or distribution, the method comprising:
detecting or acquiring at least two real or actual temperatures of a fluid, particularly sanitary hot water, that is stored in a heat storage tank, in particular a pressurized tank, at at least two different positions along the height of the heat storage tank, which is preferably a direction parallel to the direction of gravity, at least at few points in time, preferably at several points in time, and
acquiring at least one temperature distribution pattern of heat of the fluid stored in the heat storage tank and/or corresponding heat distribution pattern data by applying a temperature-distribution-pattern-algorithm to the detected or acquired at least two temperatures detected or acquired at least at few points in time, preferably at several points in time.

In this way it becomes possible to more accurate estimation and monitoring of the available and/or usable hot water content of a hot water storage tank while improving the energy efficiency of domestic hot water production and/or distribution. Moreover, since it becomes possible to accurately estimate the heat and/or equivalent hot water stored in a hot water storage tank by only using temperature sensors, the need of a flow detector for detecting the amount of hot water tapped from the hot water storage tank becomes obsolete. In the present invention, the term “monitoring” concerning the “monitoring of domestic hot water production and/or distribution” is used to define that the production of for example domestic hot water is detected and optionally recorded using virtual and real temperature sensors. For example, when hot water is tapped from the hot water storage tank, a change or alteration in the temperature distribution pattern in the hot water storage tank is detected and/or determined and based thereon is an amount of heat (kWh) remaining in the hot water storage tank and/or tapped from the hot water tank determined and/or recorded.

Moreover, the term “controlling” concerning the “controlling domestic hot water production and/or distribution” defines in the present invention that for example based on detected temperatures or detected flow rates and/or based on estimated values or patterns, like the temperature distribution pattern, the production of domestic hot water is changed, for example increased or decreased by starting or stopping heating of the stored hot water by the loading coil.

Furthermore, the term “production” concerning the “monitoring and/or controlling domestic hot water production” defines in the present invention the production of hot water, meaning the increase of the temperature above 40° C. In more detail, in order to produce a certain amount of domestic hot water, the loading coil is provided with a hot fluid, which is for example heated and provided by a heat pump. By heat transfer between the fluid flowing through the loading coil and hot water stored in the hot water storage tank, the hot water stored in the tank is heated, meaning the temperature of the hot water is increased.

Yet, in the present invention the term “distribution” concerning the “monitoring and/or controlling domestic hot water distribution” defines the distribution or making available (providing) of hot water, particularly water with a temperature above 40° C., to respective users, like a shower or a bathroom.

The computer-implemented method may further comprise:
acquiring or simulating a plurality of virtual temperatures, preferably at least 5 virtual temperatures, particularly more than 10 virtual temperatures, more particularly more than 20 virtual temperatures, of the fluid stored in the heat storage tank at different positions along the height of the heat storage tank by applying a virtual-temperature-sensor-algorithm to the detected at least two real or actual temperatures
detected at least at few points in time, preferably at several points in time, and acquiring or simulating the temperature distribution pattern of heat stored in the heat storage tank and/or corresponding heat distribution pattern data by applying the temperature-distribution-pattern-algorithm to the detected at least two real or actual temperatures and the acquired or simulated plurality of virtual temperatures, where preferably the virtual temperatures are acquired or simulated by using a neural network.

The computer-implemented method may further comprise:
determining an amount of heat, in particular an amount of equivalent hot water (EHW, V40), stored in the heat storage tank by applying a heat-estimation-algorithm to the acquired temperature distribution pattern and/or the detected at least two real or actual temperatures and the acquired plurality of virtual temperatures, and/or
acquiring at least two temperature distribution patterns and/or corresponding heat pattern data by applying the temperature-distribution-pattern-algorithm to at least two sets of acquired temperatures, preferably a plurality of sets of detected and/or acquired temperatures, preferably comprising the detected real temperatures and/or the acquired virtual temperatures, which are detected at least at two different points in time, and
determining an amount of heat, in particular an amount of equivalent hot water, tapped from the heat storage tank by applying a tapping-estimation-algorithm to the at least two temperature distribution patterns (indirect tapping estimation).

According to a further aspect, the temperature distribution pattern acquiring step, in particular the temperature-distribution-pattern-algorithm, of the computer-implemented method comprises:
determining the temperature distribution pattern of the heat stored in the heat storage tank by processing the detected at least two real or actual temperatures, detected at least at few points in time, preferably at several points in time, more particularly the detected at least two real or actual temperatures and the acquired or simulated plurality of virtual temperatures, using a regression-algorithm, wherein the regression-algorithm is preferably trained on temperature data defining temperature distribution patterns of the heat stored in the heat storage tank using one or more machine-learning-algorithms.

Moreover, the regression-algorithm of the computer-implemented method may be trained on:
Temperatures and/or temperature data detected by a plurality of temperature sensors, preferably including the two temperature sensors used for detecting the at least two temperatures, provided at different positions along the height of the heat storage tank, and/or
heat coil input and/or output temperature(s), particularly during heating/heat up of the fluid stored in the heat storage, and/or
flow rate(s) at an inlet and/or an outlet of the fluid into/from the heat storage tank, and/or
flow rate of the fluid (heating fluid) flowing through the heat coil.

Further, the computer-implemented method may comprise: acquiring a flow rate and/or amount of fluid, in particular amount of hot water, tapped from the heat storage tank by using at least one flow rate sensor, preferably arranged at an outlet of the fluid from the heat storage tank, and/or determining an amount of heat, in particular an amount of equivalent hot water (EHW, V40), tapped from the heat storage tank by applying an indirect-tapping-estimation-algorithm to the at least two temperature distribution patterns and a flow rate of the fluid flowing through the heat coil (indirect tapping estimation).

Moreover, in the computer-implemented method at least one temperature distribution pattern may be acquired and/or determined by using:
the at least two temperature sensors, in particular real temperature sensors, and
a plurality of virtual temperature sensors, preferably at least 5 virtual temperature sensors, particularly more than 10 virtual temperature sensors, more particularly more than 20 virtual temperature sensors, which are used for acquiring the plurality of virtual temperatures, preferably the at least 5 virtual temperatures,
wherein the virtual temperature sensors are preferably provided and/or simulated by an (artificial) neural network.

In the present invention, the term “real” in “real temperature” and “real temperature sensors” is used for defining temperature sensors that are (actually) physically provided in the system for monitoring and/or controlling domestic hot water production and hence actually measure real (live) temperatures. In other words, the real temperature sensors are in fact physically provided at the heat storage tank and actually measure a temperature of the fluid stored in the heat storage tank.

On the other hand, the term “virtual” in “virtual temperatures” and “virtual temperature sensors” is used in the present invention to define that the sensors are not physically provided in the system for monitoring and/or controlling domestic hot water production. Instead, the virtual temperature sensors are somewhat simulated by the neural network as explained below in more detail. The temperature values of the virtual sensors are determined by the trained neural network based on the inputs of the real temperature sensors, hence, the acquired or simulated temperatures are called “virtual temperatures”.

Furthermore, the computer-implemented method may comprise: acquiring a user consumption pattern by applying a user-consumption-algorithm to:
a) the acquired temperature distribution pattern(s) of the heat stored in the heat storage tank, and/or
b) the determined amount of heat or amount of equivalent hot water, stored in the heat storage tank, and/or
c) the determined amount of heat or equivalent hot water tapped from the heat storage tank by using the indirect-tapping-estimation-algorithm, and/or
d) the determined amount of fluid or hot water tapped from the heat storage tank by using the at least one flow rate sensor.

Moreover, the computer-implemented method may further comprise: determining a heating pattern and/or hot water production control pattern of the fluid stored in the heat storage tank by applying a heating-pattern-algorithm to the acquired user consumption pattern, wherein the user consumption pattern and/or the heating pattern and/or hot water production control pattern is/are divided into time increments of one day, 12 hours, 6 hours, 1 hour, 30 minutes, 10 minutes, and/or 1 minute.

This means, the user consumption pattern is for example a collection of the acquired temperature distribution pattern(s) of the heat stored in the heat storage tank and/or the determined amount of heat or amount of equivalent hot water, stored in the heat storage tank, at a plurality of timepoints, for example 10 times per hour, and based on the ten data sets an average value is calculated which defines and/or characterizes one increment, in this case an increment of one hour. Based on the acquired increments, a user consumption pattern can be determined. Same applies for the heating pattern and/or hot water production control pattern.

For example, does a user consumption pattern show that a specific user always has a high domestic hot water demand at a specific time, for example in the morning from 6 am to 8 am (taking shower), the heating pattern can be adapted accordingly, meaning that at the time from 6 am to 8 am an unusual high amount of hot water is made available.

Furthermore, in the computer-implemented method at least ten, preferably at least twenty, more preferably at least thirty temperatures may be acquired at least at ten points in time, preferably at least at twenty points at time, more preferably at least at thirty points in time, before a temperature distribution pattern of the heat storage tank is determined.

In this way, an accuracy in determining the temperature distribution pattern can be improved. In detail, before a temperature distribution pattern is determined, a plurality of temperature sets of the at least two temperatures is acquired at several points in time and based on the plurality of temperature sets (history) a temperature distribution pattern is determined using an (artificial) neural network.

Moreover, the invention provides a computer-implemented method of monitoring and/or controlling domestic hot water production and/or distribution, particularly by monitoring and/or controlling a system for monitoring and/or controlling domestic hot water production and/or distribution, the method comprising:
detecting at least two real temperatures of a fluid, particularly sanitary hot water, that is stored in a heat storage tank, in particular a pressurized tank, at at least two different positions along the height of the heat storage tank at least at few points in time,
acquiring an amount of fluid tapped from the heat storage tank by applying a fluid-tapping-estimation-algorithm to the at least two real temperatures detected at least at few points in time, and
acquiring an amount of heat or an amount of equivalent hot water tapped from the heat storage tank by applying a direct-tapping-estimation-algorithm to the acquired amount of fluid tapped from the heat storage tank and a topmost layer temperature of the heat storage tank.

Furthermore, in the computer-implemented method the topmost layer temperature may be detected by a temperature sensor, particularly a real temperature sensor, that is provided near an outlet of the heat storage tank, and/or acquired by the topmost real or virtual temperature sensor of the above described computer-implemented method.

The invention further provides a controller for monitoring and/or controlling a domestic hot water production and/or distribution system having a control unit and means adapted to execute the above described steps of the computer-implemented method.

The invention further provides a system for monitoring and/or controlling domestic hot water production and/or distribution having a controller, in particular the above described controller, and means adapted to execute the above described steps of the computer-implemented method.

The system may further comprise:
a heat storage tank, particularly a hot water storage tank, more particularly a pressurized hot water storage tank, and
at least two temperature sensors that are provided at two different positions along the height of the hot water storage tank and configured to detect the temperature of a fluid, particularly sanitary hot water, that is stored in the hot water storage tank.

Moreover, in the system the number of the at least two temperature sensors is at most 5, preferably at most 4, more preferably at most 3, and one of the at least two temperature sensors is preferably located in a bottom half of the heat storage tank, more preferably in a bottom third of the heat storage tank.

Since the controller and the system are adapted to execute the above described steps of the computer-implemented methods, the further features disclosed in connection with the computer-implemented methods may also be applied to the controller and the system. The same applies vice versa for the computer-implemented methods.

The invention further provides a computer program comprising instructions to cause the above described controller for a domestic hot water production and/or distribution system and/or the above described system for domestic hot water production and/or distribution to execute the above described steps of the computer-implemented method of monitoring and/or controlling domestic hot water production and/or distribution.

Moreover, the invention provides a computer-readable medium having stored thereon the above described computer program for monitoring and/or controlling domestic hot water production and/or distribution.

In this regard, the above described computer-implemented method cannot only be performed by the controller and the system which are adapted to execute the described steps of the computer-implemented method, the method can also be performed by cloud-computation. Meaning, the data of the real temperature sensors of a specific heat storage tank are sent to the cloud, the cloud is adapted to execute the above described steps of the computer-implemented method and sends back the acquired data like temperature distribution pattern, equivalent hot water stored in the heat storage tank, heat and/or equivalent hot water tapped from the heat storage tank, consumer pattern etc. to a controller and/or user of the respective system for monitoring and/or controlling domestic hot water.

Since the computer program and the computer-readable medium are also related to the above described controller and system for domestic hot water production and/or distribution, the further features disclosed in connection with the computer-implemented methods, the controller and the system may also be applied to the computer program and the computer-readable medium and vice versa.

### BRIEF DESCRIPTION OF DRAWINGS

A more complete appreciation of the present disclosure and many of the attendant ad-vantages thereof will be readily obtained as the same becomes better understood by reference to the following detailed description when considered in connection with the accompanying drawings, in which:

FIG. 1 is a schematic illustration showing a conventional forecast system for a water boiler system;

FIG. 2 is a schematic illustration of a system for monitoring and/or controlling domestic hot water production and/or distribution shown in a deployed stage according to a first embodiment of the present disclosure;

FIG. 3 is a schematic illustration of a system for monitoring and/or controlling domestic hot water production and/or distribution shown in a training stage according to a second embodiment of the present disclosure;

FIG. 4 is a block diagram illustrating an example signal processing hardware configuration of the system of FIG. 2, according to a further embodiment of the present disclosure;

FIG. 5 is a flow diagram illustrating a process of generating a domestic hot water consumption forecast according to one embodiment of the present disclosure;

FIG. 6 is a schematic illustration of a system for controlling domestic hot water production and/or distribution according to a further embodiment if the present disclosure;

FIG. 7 is a schematic illustration shown three different models for generating a domestic hot water consumption forecast and using said for smart control of domestic hot water production and/or distribution;

FIG. 8 is a flow diagram illustrating a process by which the system of FIG. 2 acquires a temperature distribution pattern TDP₁ of heat stored in the heat storage tank and determines an amount of heat or an amount of equivalent hot water stored, in accordance with an embodiment of the present disclosure;

FIG. 9 is a flow diagram illustrating an offline data collecting process for a training process of the system in the training stage shown in FIG. 3;

FIG. 10 is a block diagram illustrating a process by which the system of FIG. 2 determines an amount of heat (EHW, V40) stored in the heat storage tank, in accordance with an embodiment of the present disclosure;

FIG. 11 is a block diagram illustrating a process by which the system of FIG. 2 determines an amount of heat tapped from the heat storage tank, in accordance with a further embodiment of the present disclosure;

FIG. 12 is a flow diagram illustrating a training process of the temperature distribution estimator of FIGS. 10 and 11 in accordance with an embodiment of the present disclosure;

FIG. 13 is a flow diagram illustrating a training process of the direct tapping estimator of FIG. 10 in accordance with a further embodiment of the present disclosure;

FIG. 14 is a schematic illustration of a neural network comprising artificial neurons in an input layer, a hidden layer, and an output layer;

FIG. 15 is a schematic illustration of a neural network of a user-consumption-pattern-determination-algorithm in accordance with an embodiment of the present disclosure; and

FIG. 16 is a diagram illustrating a user consumption pattern acquired by the system for monitoring and/or controlling domestic hot water production and/or distribution shown in FIG. 2.

FIG. 17 is a schematic illustration showing a heat storage tank in a configuration without a coil.

### DESCRIPTION OF EMBODIMENTS

### Detailed Description

Several embodiments of the present disclosure will now be explained with reference to the drawings. It will be apparent to those skilled in the field of domestic hot water production and/or distribution from this disclosure that the following description of the embodiments is provided for illustration only and not for the purpose of limiting the disclosure as defined by the appended claims.

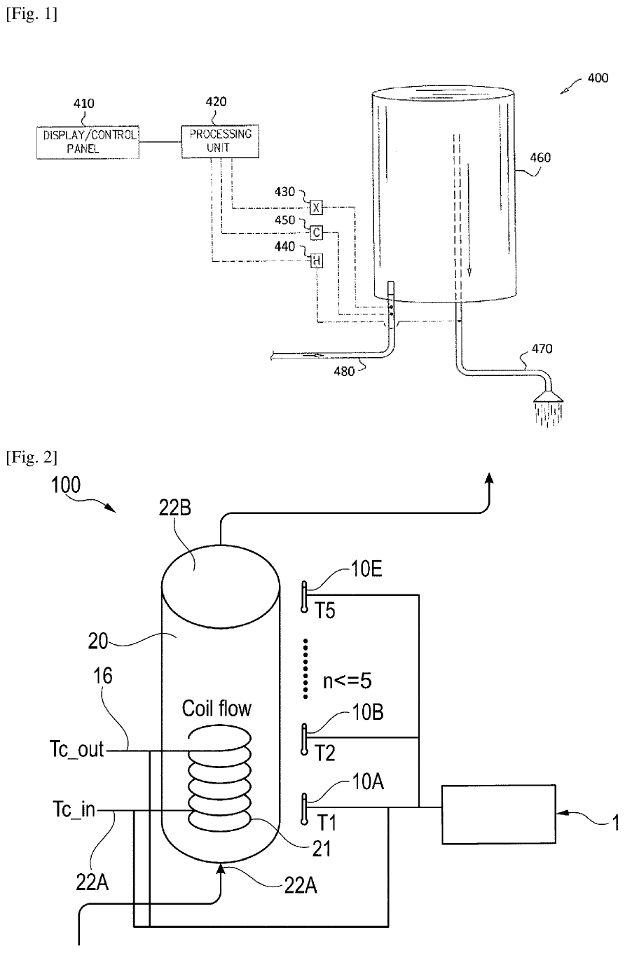

FIG. 1 is a schematic illustration showing a conventional forecast system for a water boiler system. In FIG. 1 a water heater (boiler) system 400 is augmented with an immediate monitoring and forecast system. A typical water boiler system includes a water boiler 460, a cold-water intake pipe 480 which brings in cold water from an external source, and a hot water outlet pipe 470 from the boiler (usually located near the top of the boiler where the hottest water is found) to a household system of pipes for dispersion throughout the house (e.g. to the bathroom, kitchen, laundry room etc.). The system collects data form three sensors assembled on the boiler: a first temperature sensor (C) 450 measures the temperature of the water in the intake line 480; a second temperature sensor (H) 440 measures the temperature of the water in hot-water outlet pipe leading out of the boiler; and a flow meter (X) 430 which measures the flow rate of water moving through the cold-water intake line, into the boiler. The flow rate sensor can be placed on either the intake or outlet lines as the boiler system is a closed system. The system analysed input from the sensors, calculates the amount of available hot water and displays a real-time estimation of water availability on a display unit 410 which is preferably located in a bathing area such as a shower or bathroom.

FIG. 2 is a schematic illustration of a system for monitoring and/or controlling domestic hot water production and/or distribution shown in a deployed stage according to a first embodiment of the present disclosure. The shown system comprises a controller 1 for monitoring and controlling domestic hot water production and distribution, a heat storage tank 20 for storing heated water, particularly water that is heated above 40° C., and five temperature sensors 10A to 10B for detecting the temperature of the hot water stored in the heat storage tank 20.

Moreover, as shown FIG. 2, the heat storage tank 20 which is preferably a pressurized tank comprises a coil or loading coil that is located in the bottom half of the tank. Alternatively, the tank may have a configuration without a coil where the heat exchanger/heat source can be placed outside the tank or can be a part of the tank. In this case, the hot water is injected and circulated as shown in FIG. 17.

Since the temperature distribution of the hot water stored in the heat storage tank 20 or hot water storage tank is layered (layer stratification), which means that even if the water near the bottom is cold (below 40° C.), hot water can still be tapped from the tank. In case the heat source for heating the hot water stored in the heat storage tank 20 is for example a heat pump, the heat pump can operate in the initial phase of the tank heat up in a better COP, since the provided hot water only needs to have a temperature slightly (ΔT about 3° C.) higher than the temperature of the water at the bottom half of the tank.

Moreover, since the hot water stored in the heat storage tank 20 is layered, the temperature increases continuously from the bottom of the tank to the top of the tank, leading to a characteristic temperature distribution pattern. As the temperature is increasing from the bottom of the tank to the top of the tank, the temperature sensors 10A to 10E, provided at different positions along the height of the hot water storage tank 20, measure different temperatures dependent on the location/height of the respective sensor.

The shown hot water storage tank 20 is provided with a cold-water intake/inlet 22A which lets in cold water from an external source and a hot water outlet/outlet 22B for tapping hot water from the hot water storage tank 20. The inlet 22A is provided in a bottom third of the tank and the outlet 22B is located near the top of the tank where the hottest water is found. From the outlet 22B the hot water can for example be distributed to a household by pipes for dispersion throughout the house.

Moreover, the shown system 100 comprises further a pair of temperature sensors 15, 16 for detecting the inlet temperature and outlet temperature of the fluid (heating fluid) flown through the loading coil.

The system uses the controller 1 to acquire by using the (real) temperature sensors 10A to 10E five (real) temperatures T_{1R_t0} to TER wo of the layered hot water stored in the hot water storage tank 20. Based on the acquired five real temperatures T_{1R_t0} to T_{SR_t0} the system further acquired a temperature distribution patter TDP₁ of heat stored in the hot water storage tank 20 and corresponding heat distribution pattern data. In order to determine the temperature distribution patter TDP₁ and the corresponding heat distribution pattern data, the controller 1 applies a temperature-distribution-pattern-algorithm that will be explained in more detail below. Based on the acquired heat-distribution-pattern-algorithm the controller 1 then determines an amount of heat, in particular an amount of equivalent hot water, stored in the hot water storage tank 20, this is also done by applying a heat-estimation-algorithm to the acquired temperature distribution pattern (TDP₁).

When the above described process is repeated over the time, particularly after a certain amount of hot water has been tapped from the tank 20 or the temperature of the hot water stored in the tank 20 has dropped because of heat loss to the surrounding environment, the system can acquire several temperature distribution patterns TDP₁, TDP₂ to TDPₙ. Based on the acquired temperature distribution patterns TDP₁, TDP₂ to TDPₙ the controller can determine a remaining amount of heat in the hot water storage tank 20 and an amount of heat, in particular an amount of equivalent hot water, tapped from the heat storage tank by applying an indirect-tapping-estimation-algorithm to the acquired temperature distribution patterns TDP₁, TDP₂ to TDPₙ.

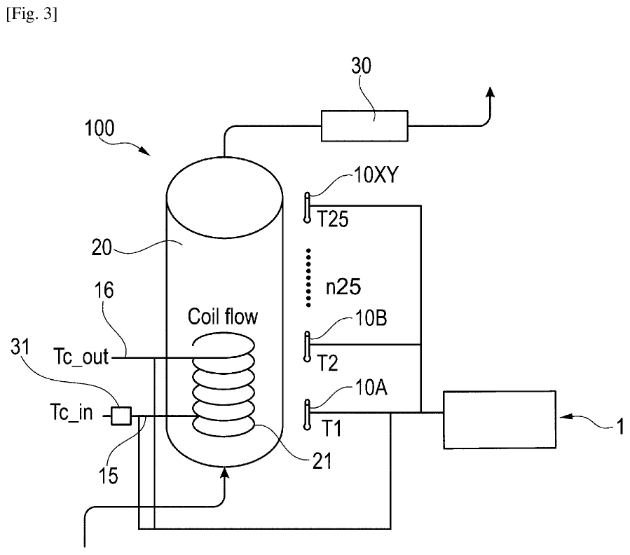

FIG. 3 is a schematic illustration of a system for monitoring and/or controlling domestic hot water production and/or distribution shown, particularly the one of FIG. 2, in a training stage according to a second embodiment of the present disclosure. The shown system comprises all components explained above with regard to the system shown in FIG. 2. Furthermore, the system is provided for training purposes with additional 20 (real) temperature sensors, which are also provided along the height of the hot water storage tank 20 on different positions, a flow rate sensor 30 for measuring a flow rate of the hot water tapped from the hot water storage tank 20 and a flow rate sensor 31 for measuring a flow rate of the fluid (heating fluid) flowing through the coil.

As explained above, this system 100 is used for training the system to acquire or determine or simulate the temperature distribution pattern of the heat or hot water stored in the heat storage tank or hot water storage tank 20. The training of the system, particularly of the temperature-distribution-pattern algorithm, heat-estimation-algorithm, indirect-tapping-estimation-algorithm and the regression-algorithm is explained in more detail below.

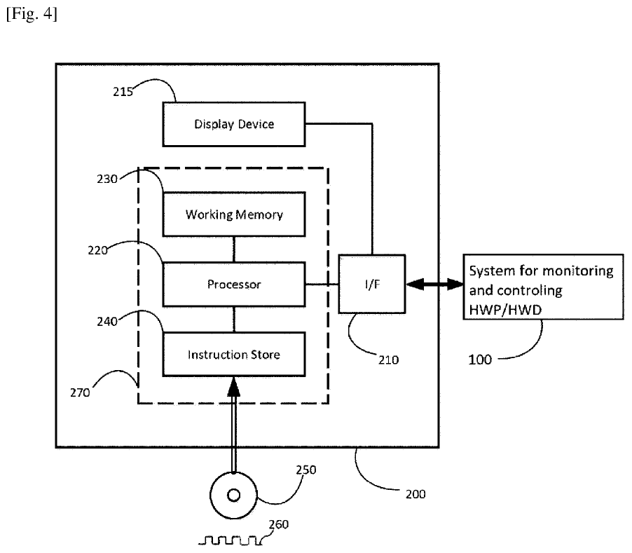

FIG. 4 is a block diagram illustrating an example signal processing hardware configuration of the system of FIG. 2, according to a further embodiment of the present disclosure, which may be configured to function as the controller 1 of FIG. 2. The programmable signal processing hardware 200 comprises a communication interface (I/F) 210 for receiving the (real) temperature data of the (real) temperature sensors 10A to 10E described above, generating the instruction for the system 100 for monitoring and/or controlling domestic hot water production and/or distribution to perform the temperature measurement on the hot water storage tank 20, receiving the measurement data from the (real) temperature sensors 10A to 10E, determining a temperature distribution pattern TDP of heat stored in the heat storage tank 20 and corresponding heat distribution pattern data, and, optionally, for determining an amount of heat stored in the heat storage tank and/or determining an amount of heat tapped from the heat storage tank, and for outputting display control signals for controlling the display device 215 to display the heat distribution pattern, the amount of heat stored in the heat storage tank and/or the amount of heat tapped from the heat storage tank. The signal processing apparatus 200 further comprises a processor, the control unit 2, (e.g. a Central Processing Unit, CPU, or Graphics Processing Unit, GPU) 220, a working memory 230 (e.g. a random access memory) and an instruction store 240 storing a computer program comprising the computer-readable instructions which, when executed by the processor 220, cause the processor 220 to perform various functions including those of the system 100 for monitoring and/or controlling domestic hot water production and/or distribution and optionally, a display control signal generator. The instruction store 240 may comprise a ROM (e.g. in the form of an electrically-erasable programmable read-only memory (EEPROM) or flash memory) which is pre-loaded with the computer-readable instructions. Alternatively, the instruction store 240 may comprise a RAM or similar type of memory, and the computer-readable instructions of the computer program can be input thereto from a computer program product, such as a non-transitory, computer-readable storage medium 250 in the form of a CD-ROM, DVD-ROM, etc. or a computer-readable signal 260 carrying the computer-readable instructions. In any case, the computer program, when executed by the processor, causes the processor to execute at least one of the methods of monitoring and/or controlling domestic hot water production and/or distribution described herein. It should be noted, however, that the controller 1 may alternatively be implemented in non-programmable hardware, such as an application-specific integrated circuit (ASIC).

In the present embodiment of the present disclosure, a combination 270 of the hardware components shown in FIG. 4, comprising the processor 220, the working memory 230 and the instruction store 240, is configured to perform functions of the system 100 for monitoring and/or controlling domestic hot water production and/or distribution, which functions will now be described in detail below. In aspects like the present aspect of the present invention, where the system 100 comprises a display control signal generator, the functionality of this optional component also be provided by the combination 270 of the hardware components, together with the communication I/F 210.

As will become more apparent from the following description of the operations performed by the controller 1 and/or the system 100 of the present aspect, the controller 1 and/or the system 100 automatically processes temperatures and/or temperature date and optionally flow rates and/or flow rate data acquired by respective sensors, in order to determine a very accurate heat distribution pattern TDP of heat or equivalent hot water stored in the heat storage tank or hot water storage tank.

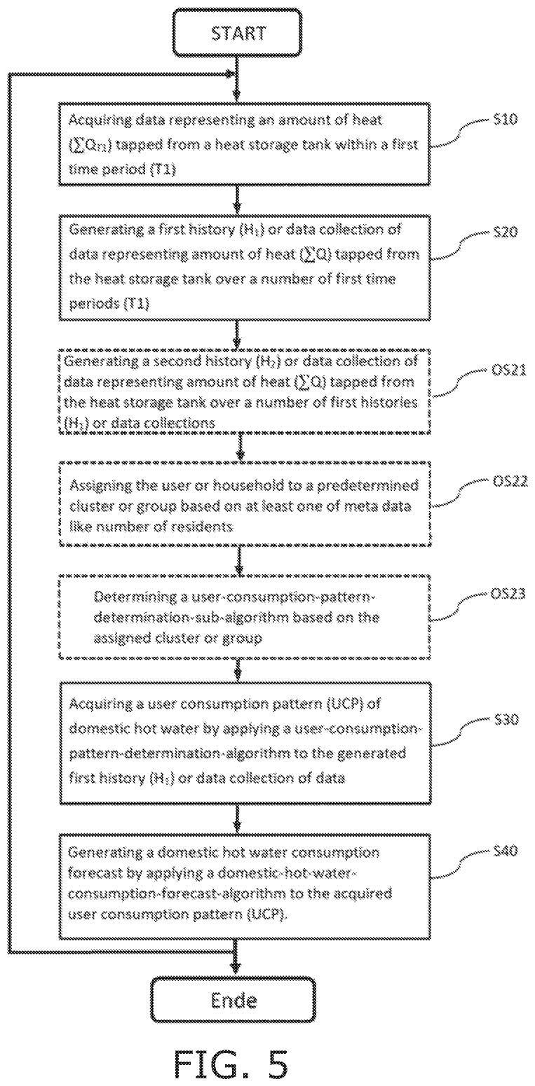

FIG. 5 is a flow diagram illustrating a process of generating a domestic hot water consumption forecast according to one embodiment of the present disclosure.

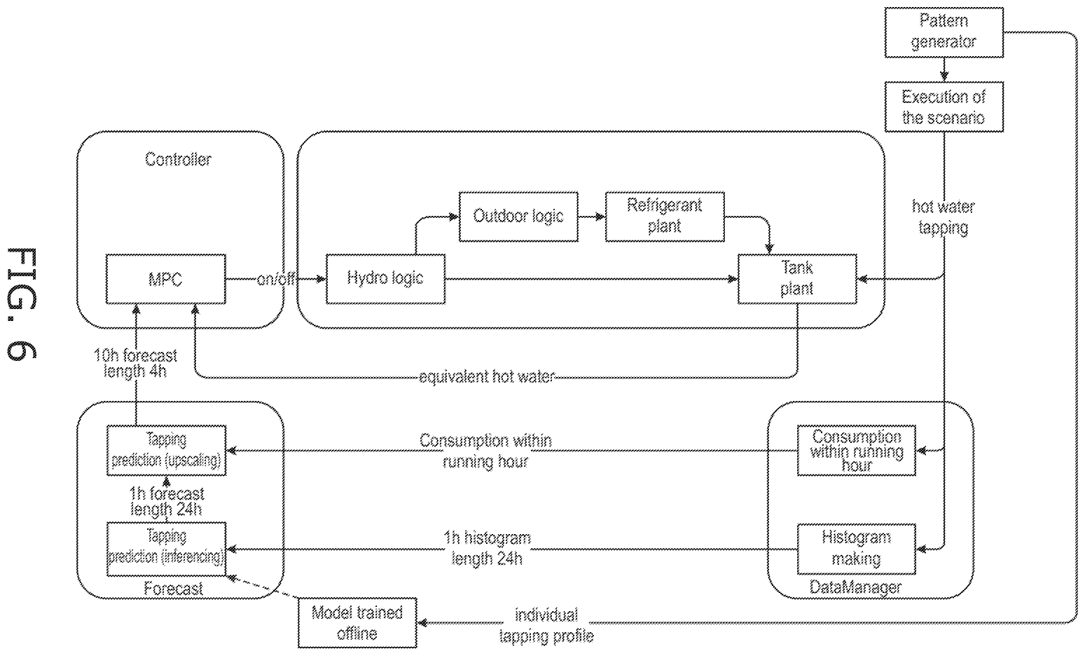

FIG. 6 is a schematic illustration of a system for controlling domestic hot water production and/or distribution according to a further embodiment if the present disclosure.

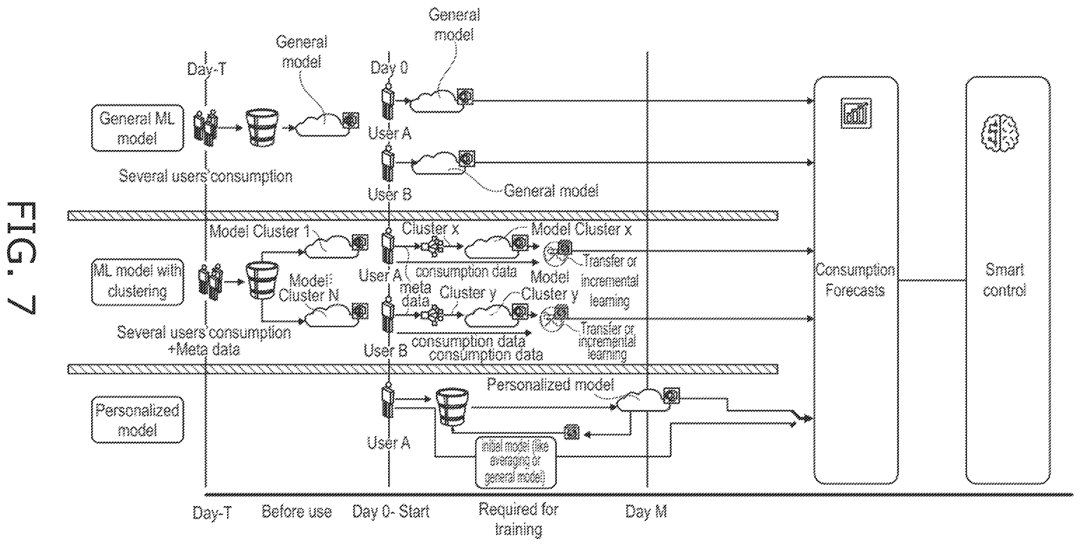

FIG. 7 is a schematic illustration shown three different models for generating a domestic hot water consumption forecast and using said for smart control of domestic hot water production and/or distribution.

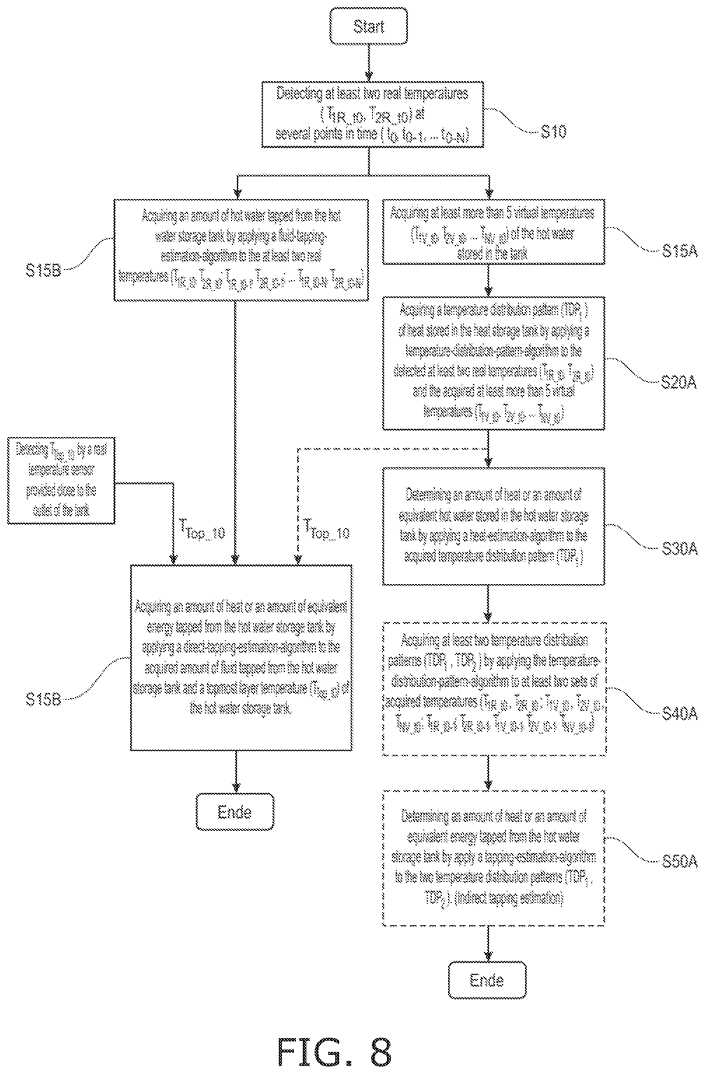

FIG. 8 is a flow diagram illustrating a process by which the system 100 of FIG. 2 acquires a temperature distribution pattern TDP₁ of heat stored in the heat storage tank 20 and determines an amount of heat or an amount of equivalent hot water stored in the tank 20 and optionally tapped from the heat storage tank 20. Moreover, FIG. 5 illustrates an alternative process for acquiring an amount of heat or an amount of equivalent hot water tapped from the heat storage tank 20.

In process S10 of FIG. 8, the controller 1, in particular the control unit 2, receives temperature data, particularly at least two real temperature data comprising each several real temperature measurements (T_{1R_t0}, T_{2R_t0}; T_{1R_t0-1}, T_{2R_t0-2}; T_{1R_t-n}, T_{2R_tn}) at several points in time (history), from real temperature sensors provided on the hot water storage tank 20 and configured to detect temperatures of the hot water stored in the tank 20.

In process S15A of FIG. 8, the controller 1, in particular the control unit 2, acquires a plurality of virtual temperatures (T_{1V_t0}, T_{2V_t0}, . . . . T_{NV_t0}) of the hot water stored in the hot water storage tank 20 by applying a virtual-temperature-sensor-algorithm to the detected at least two real temperatures detected at least at few points in time.

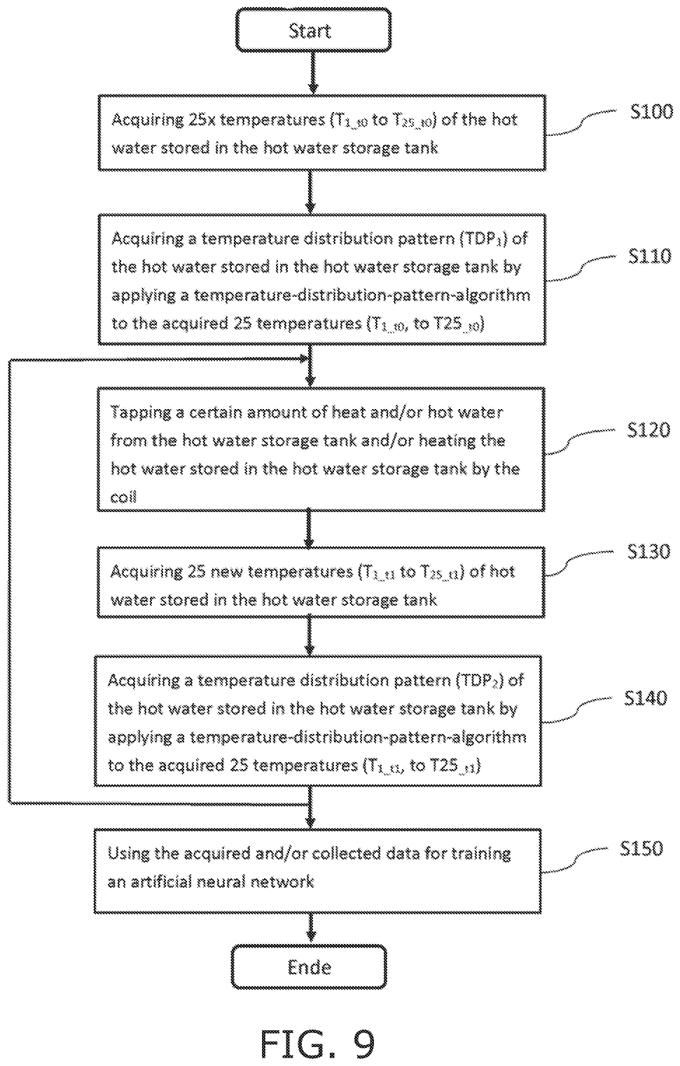

In process S20A of FIG. 8, the controller 1, in particular the control unit 2, acquires a (first) temperature distribution pattern TDP₁ of the hot water stored in the hot water storage tank 20 by applying a temperature-distribution-pattern-algorithm to the acquired at least two real temperatures (T_{1R_t0}, T_{2R_t0}: T_{1R_t0-1}, T_{2R_t0-2}; T_{1R_t-n}, T_{2R_tn}) and the acquired plurality of virtual temperatures (T_{1V_t0}, T_{2V_t0}, . . . . T_{NV_t0}). The used machine-learning temperature-distribution-pattern-algorithm was trained before by using the above with reference to FIG. 3 described system 100 for training/simulation. The training/machine-learning of the temperature-distribution-pattern-algorithm will be explained in more detail below with reference to FIGS. 9, 10 and 11.

Moreover, in process S30A of FIG. 8, the controller 1, in particular the control unit 2, determines an amount of heat, in particular an amount of equivalent hot water, stored in the heat storage tank or hot water storage tank 20 by applying a heat-estimation-algorithm to the acquired temperature distribution pattern TDP₁.

Yet, in an optional process (indicated by dashed line), as shown in FIG. 8, the process S20 is repeated at least once S40A and thereby at least two temperature distribution patterns TDP₁, TDP₂ are determined by applying the above described temperature-distribution-pattern-algorithm to at least two sets of acquired temperatures T_{1R_t0}, T_{2R_t0}, T_{1V_t0}, T_{2V_t0} . . . T_{NV_t0}; T_{1R_t0-1}, T_{2R_t0-1}, T_{1V_t0-1}, T_{2V_t0-1}, . . . T_{NV_t0-1}).

In a further optional process (indicated by dashed line), in a process S50A shown in FIG. 8 an amount of heat and/or amount of equivalent hot water, tapped from the heat storage tank or hot water storage tank 20 is determined by apply an indirect-tapping-estimation-algorithm to the two acquired temperature distribution patterns TDP₁, TDP₂.

As already explained above with respect to FIG. 3, in the training phase of the system 100 (training system), the system 100 is not only provided with the at least two (real) temperature sensors, but instead is provided with for example 25 (real) temperature sensors. Accordingly, in the training phase (machine-learning phase) of system 100, the controller 1 receives 25 temperature data T_{1_t0}, T_{2_t0} . . . . T_{25_t0}.

FIG. 9 is a flow diagram illustrating an offline data collecting process for a training process of the system, in particular of an artificial neural network of the system, in the training stage shown in FIG. 3. With “offline data collecting” is meant that the necessary data for training the neural network and the corresponding algorithms are collected before the training is actually performed. Meaning, at first, all necessary data are collected during a specified period, like a day, a week or several months. After the necessary data have been collected the data a pre-processed and then inputted in the neural network in order to train it.

In process S100 of FIG. 9, the controller 1, in particular the control unit 2 (processor), is receiving 25 real temperature data T_{1_t0} to T_{25_t0} of the hot water stored in the hot water storage tank 20, by using 25 real temperature sensors 10A to 10XY provided a long the height of the hot water storage tank 20.

In process S110 of FIG. 9, the controller, in particular the control unit 2, determines a temperature distribution pattern TDP₁ of the hot water stored in the hot water storage tank 20 by processing the acquired temperatures T_{1_t0}, T_{2_t0} . . . T_{1_t25-0} using the above described temperature-distribution-pattern-algorithm.

In process S120 of FIG. 9, a certain amount of heat (kWh) and/or equivalent hot water (1) is tapped from the hot water storage tank using the flow rate sensor 30 provided at the outlet of the hot water storage tank and a top tank temperature sensor 10XY (the highest sensor of the real and virtual sensors). Moreover, optionally, a heating (kWh) of the stored hot water via the coil 21 is conducted while the flow of the fluid through the coil 21 is measured by the flow rate sensor 31 of the coil and the inlet and outlet temperatures of the fluid are measured by the inlet and outlet temperature sensors 15, 16 of the coil 21.

Moreover, in process S130 of FIG. 9 new temperatures T_{1_t1} to T_{25_t1} of the hot water stored in the hot water storage tank 20 are acquired and in process S140, in line with the process S110, a temperature distribution pattern TDP₂ of the hot water stored in the hot water storage tank 20 is determined using the new acquired temperatures T_{1_t1} to T_{25_t1}.

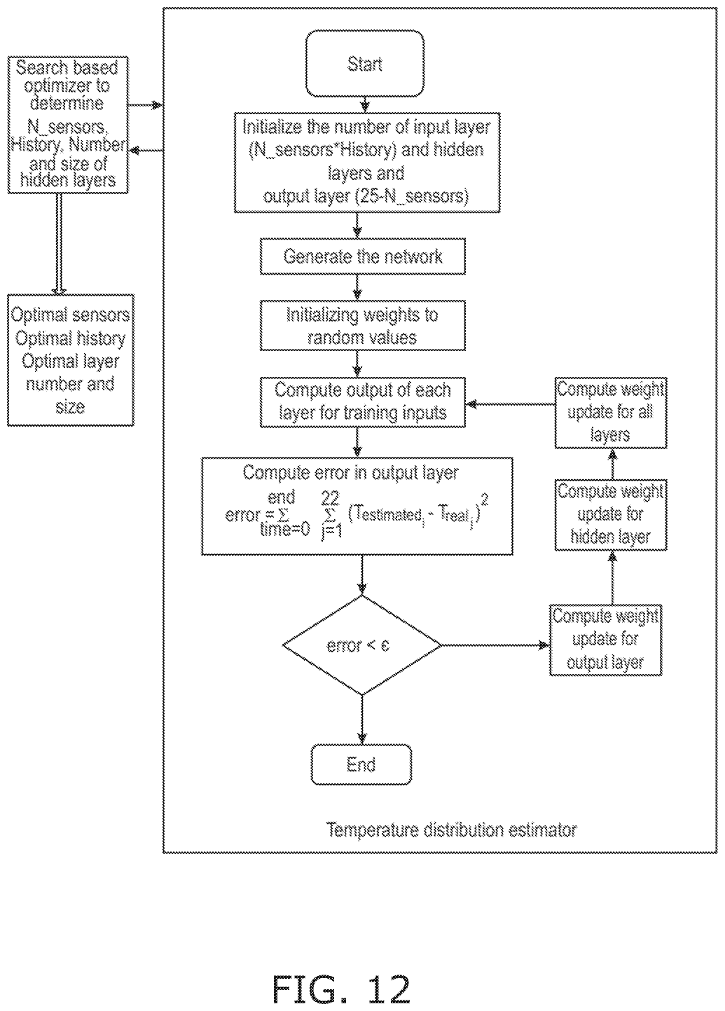

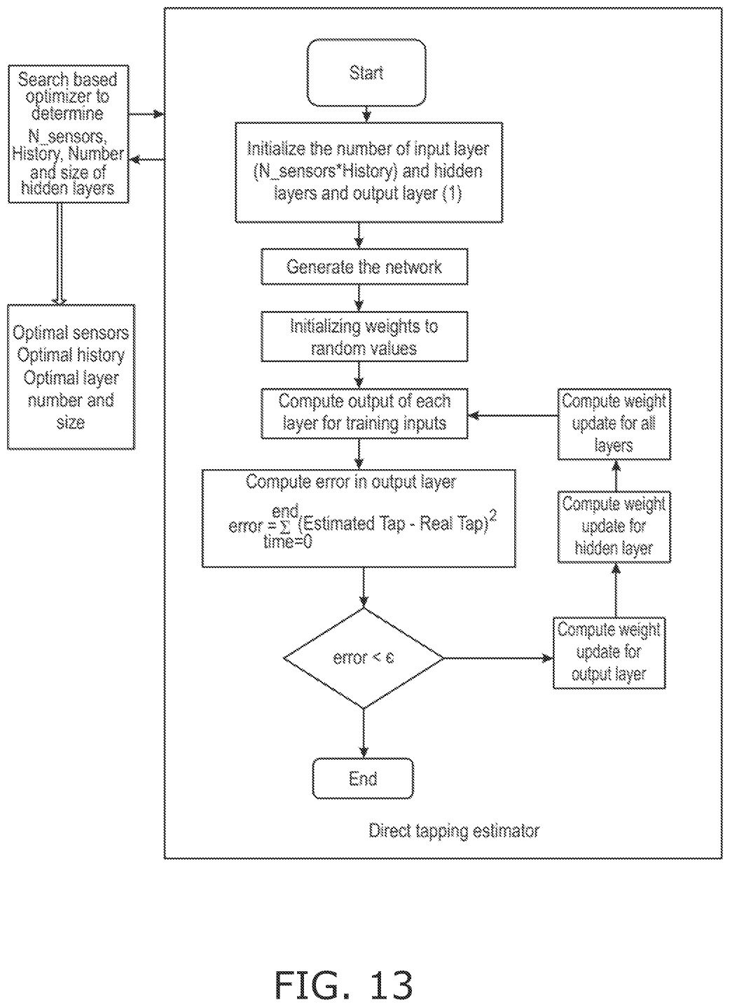

The above process is repeated continuously until sufficient data for training the neural network could be acquired and/or collected. In process S150 of FIG. 9 the acquired and/or collected data are used for training the artificial neural network. The training will be explained in more detail below with reference to FIGS. 12 and 13.

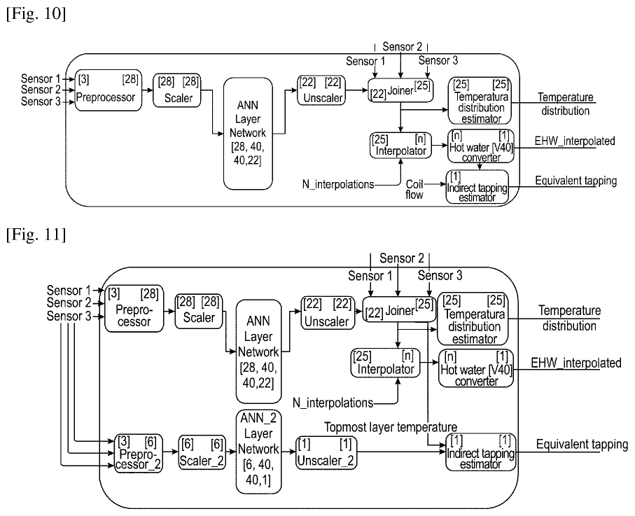

FIG. 10 is a block diagram illustrating a process by which the system 100 of FIG. 2 determines an amount of heat (remaining equivalent hot water at to (EHW, V40)) stored in the heat storage tank, in accordance with an aspect of the present invention. As shown in FIG. 10, the real temperatures detected by the at least two real temperature sensors 10A, 10B, in the present aspect Sensor 1, Sensor 2 and Sensor 3, are received by the controller 1, in particular by a pre-processor of the controller 1 or the control unit 2.

The pre-processor takes the best subset for the respective heat storage tank 20, pre-processes the real temperatures and/or temperature data received from the sensors 1 to 3 and calculates new features. By calculating new features it is meant that the pre-processor uses the history, for example real temperatures measured by the sensors 1 to 3 in the past, and provides a data package of example 28 data.

In a next step, a scaler scales the features down in preparation for a model of a neural network. The scaled features are input into an (artificial) neural network (ANN), which has been trained as described above and in more detail below with regard to FIGS. 12 and 13, and consists for example of two hidden layers of 40 nodes and estimates the remaining 22 virtual sensors (of the above described training system) based on the received features. Then, a unscaler scales the features back up to its original range and a joiner combines the data of the real three sensors 1 to 3 with the data of the virtual 22 sensors.

The data from the joiner are inputted into a temperature distribution estimator for determining the temperature distribution pattern TDP of the hot water storage tank.

Moreover, the data of the joiner are sent to an interpolator which increases the number of virtual sensors used for determining the temperature distribution pattern TDP in order to remove artefacts in the later converted or calculated heat/equivalent hot water (EHW, V40).

Additionally, after the interpolator the determined data are sent to a hot water-converter (EHW, V40) and after that optionally processed by a filter for further smoothening the output (EHW, V40) if the interpolator cannot remove all artefacts.

In a last optional step, a coil flow (l/min) detected by a flow sensor configured to detect a fluid flow through the coil is used to estimate tapping by an indirect tapping estimator. Thereby, it becomes possible to estimate the heat (kWh) and/or equivalent hot water (EHW, V40) tapped from the hot water storage tank 20. When estimating the heat (kWh) and/or equivalent hot water (1) that has been tapped from the hot water storage tank 20, the indirect tapping estimator may remove or compensate heat loss due to heat transfer to the surrounding environment and may remove or compensate heat that is added to the hot water storage tank 20 by heating via the heat coil 21.

FIG. 11 is a block diagram illustrating a process by which the system 100 shown in FIG. 2 directly determines an amount of heat and/or equivalent hot water (EHW, V40) tapped from the heat storage tank, in accordance with a further aspect of the present invention. The process or system (control unit) shown in FIG. 11 comprises all features/steps or components of the process or system shown in FIG. 10, except the indirect tapping estimator.

Additionally, the shown process includes a second (parallel) process-line for directly determining the amount of heat and/or equivalent hot water (EHW, V40) tapped from the heat storage tank. As shown, the three real temperatures detected by the sensors 1 to 3 are inputted into a second pre-processor that takes the best subset for the respective heat storage tank 20, pre-processes the real temperatures and calculates new features. Said features comprise the newly inputted real temperatures as well as previously inputted real temperatures (history).

A second scaler scales the features down in preparation for a second model of a second (artificial) neural network (ANN_2), which has been trained as described below, particularly with regard to FIG. 13, and consists for example of two different layers of 40 nodes and estimates the amount of hot water tapped from the tank. Here, only an amount of water without any indication of energy stored in the tapped water is estimated. Then, a unscaler scales the features back up to its original range and provides the estimated amount of tapped hot water to a direct tapping estimator.

The direct tapping estimator estimates heat and/or equivalent hot water that has been tapped from the hot water storage tank by using the estimated amount of tapped hot water (provided by the second neural network) and a topmost layer temperature (believed real temperature of the hot water taped from the hot water storage tank) detected by the topmost temperature sensor of the 25 sensors (22 virtual sensors+3 real sensors). When estimating the heat or equivalent hot water tapped from the hot water storage tank 20, the direct tapping estimator may remove or compensate heat loss due to heat transfer to the surrounding environment. Here, it is also possible to use instead of one of the 22 virtual sensors of the first neural network a real installed temperature sensor, thereby making the first neural network obsolete for the determination of the tapped heat or equivalent hot water.

FIG. 12 is a flow diagram illustrating a training process of the temperature distribution estimator of FIGS. 10 and 11 in accordance with an aspect of the present invention. As shown, in a first step, the numbers of input layers (number of real sensors*history (number of available data; points in time), hidden layers and output layers (number of virtual sensors) are initialized. In a next step the artificial neural network (ANN) is generated and the weights of the ANN are set in the beginning to random values.

In a next step, the output of each layer is computed for training inputs (the data which have been collected in the offline data collecting process) and an error in the output layer is computed based on the estimated values (temperatures) and the real values (temperatures).

Based on the computed error, new values (updates) for the weights of the output layer and the hidden layer of the ANN are computed and set. Then, the computing of the output of each layer using the training inputs is repeated, using the updated weights. This is done until the computed error is below a required threshold value. Once, the threshold value is reached, the training of the artificial neural network can be finished.

During the above described process, the number and position of real and virtual sensors, the history (number of temperature sets at several time points), and the optimal layer number and optimal weights can be optimized. This means, out of the for example 25 sensors, which are used during training of the neural network, the at least two sensors are chosen as the real sensors, which provide the overall best result in accuracy of estimating the temperature distribution pattern when compared with the real measured temperature distribution pattern. Same applies of the number of real and virtual sensors, number of considered previous data sets (history) and number of layers and size of the layers of the artificial neural network.

FIG. 13 is a flow diagram illustrating a training process of the direct tapping estimator of FIG. 11 in accordance with a further aspect of the present invention. Said process is in basic the same machine-learning process as shown in FIG. 12, except that instead of temperatures (temperature distribution patterns) amounts of hot water tapped from the hot water storage tank are estimated and/or trained. Accordingly, in the step of computing the error in the output layer, the estimated amount of heat and/or equivalent hot water tapped from the hot water storage tank is compared with real values measured by a flow rate sensor and if applicable a temperature sensor. By this training process the second neural network of FIG. 11 is trained.

The regression-algorithm described above may, as in the present aspect, be a neural network. Neural networks automatically generate identifying characteristics by processing the input data, such as the temperature data detected by temperature sensors 10A to 10XY, the heat coil input and/or output temperature data detected by the heat coil temperature sensors 15, 16 and the flow rate data detected by the flow rate sensors 30, 31, without any prior knowledge.

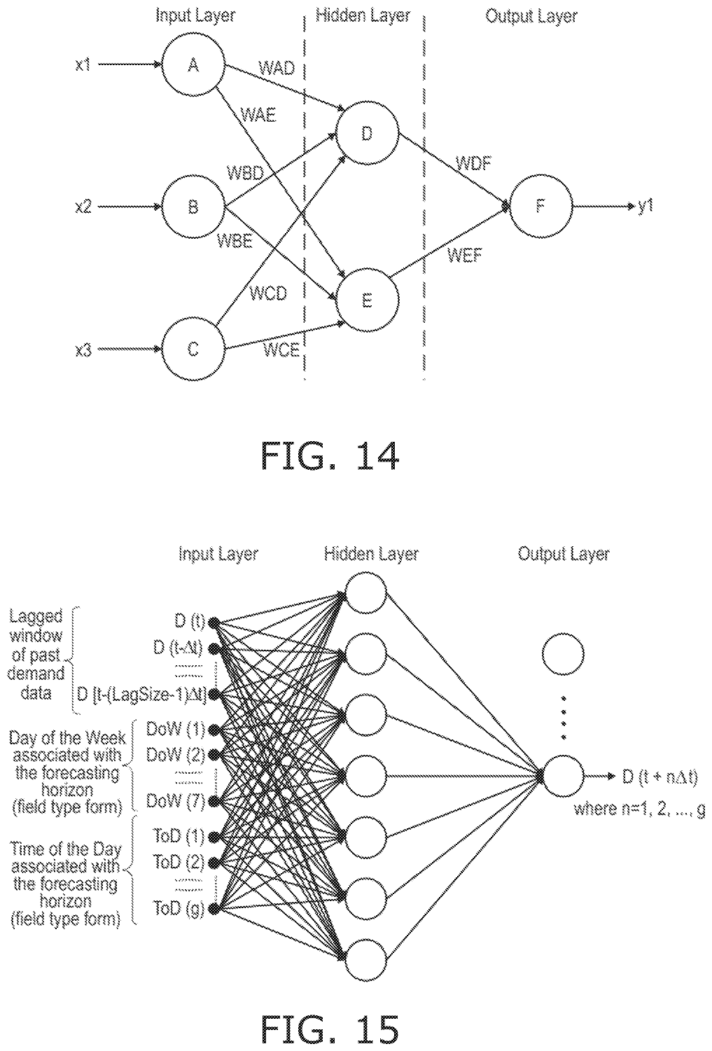

As illustrated in FIG. 14, in general, a neural network consists of an input layer and an output layer, as well as multiple hidden layers. Each of the layers is composed of a plurality of artificial neurons (labelled A to F in FIG. 14), and each layer may perform different kinds of transformations on their inputs. Each artificial neuron may be connected to multiple artificial neurons in adjacent layers. The output of each artificial neuron is computed by some non-linear function of the sum of its inputs. Artificial neurons and the connections therebetween typically have respective weights (WAD, WAE, etc. in FIG. 14) which determined the strength of the signal at a given connection. These weights are adjusted as learning proceeds, thereby adjusting the output of the neural network. Signals travel from the first layer (the input layer), to the last layer (the output layer), and may traverse the layers multiple times.

FIG. 15 is a schematic illustration of a neural network of a user-consumption-pattern-determination-algorithm in accordance with an embodiment of the present disclosure.

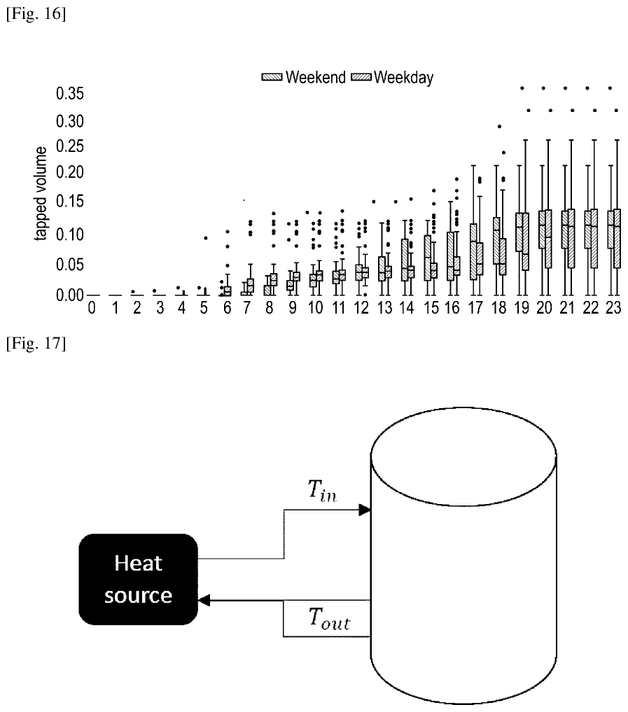

FIG. 16 is a diagram illustrating a user accumulative consumption pattern acquired by the system for monitoring and/or controlling domestic hot water production and/or distribution shown in FIG. 2. FIG. 16 shows the consumed or tapped equivalent hot water volume in m³ during weekdays and weekends. As can be taken from FIG. 16, the acquired consumption pattern (over time) does not only change during the day but also for example between weekdays and weekends.

Moreover, FIG. 17 is a schematic illustration showing a heat storage tank in a configuration without a coil.

### REFERENCE SIGNS LIST

1 Controller
2 Control Unit
10A (First) Real Temperature Sensor
10B (Second) Real Temperature Sensor
10E (Fifth) Real Temperature Sensor
15 Inlet Temperature Sensor Coil
16 Outlet Temperature Sensor Coil
20 Heat Storage Tank
21 Heat coil
22A Inlet/Cold-Water Intake
22B Outlet/Hot-Water Outlet
30 Hot-Water Outlet Flow Rate Sensor
31 Heating Fluid Flow Rate Sensor

### CITATION LIST

### Patent Literature

[PTL 1] US 2015/0226460 A1

### Non Patent Literature

[NPL1] EN16147

1. A computer-implemented method of acquiring a user consumption pattern of domestic hot water, the method comprising:
acquiring data representing an amount of equivalent energy tapped from a heat storage tank within a first time period, the heat storage tank being a pressurized tank;
generating a first history or data collection of data representing an amount of cumulative heat, tapped from the heat storage tank over a number of first time periods; and
acquiring a user consumption pattern of domestic hot water by applying a user-consumption-pattern-determination-algorithm to the generated first history or data collection of data representing amount of cumulative heat tapped from the heat storage tank,
the user-consumption-pattern-determination-algorithm being a time-series-forecast-algorithm,
trained on history or data collection representing amount of cumulative beat tapped from the heat storage tank or equivalent heat storage tanks and
defining user consumption patterns in one or more machine-learning-algorithms.

2. The computer-implemented method according to claim 1, further comprising:
generating a second history or data collection of data representing amount of cumulative heat tapped from the heat storage tank over a number of first histories or data collections,
the first history or data collection extending over a time period of one day or 24 hours and the second history or data collection extending over a time period of one week or 7 days or 168 hours.

3. The computer-implemented method according to claim 1, wherein
at least one of
the first time period extends over one week, two days, one day, 12 hours, 8 hours, 6 hours, 4 hours, 1 hour, 30 minutes, 10 minutes or 1 minute, and
the number of first time periods of the first history or data collection is 1, 2, 3, 4, 6, 24, 48, 144 or 1440.

4. The computer-implemented method according to claim 1, wherein
the user-consumption-pattern-determination-algorithm is trained on
history data or data collection representing amount of cumulative heat tapped by a plurality of users or households over a second time period, and
hour of day of the respective first time period within the respective history or data collection of data representing amount of cumulative heat tapped.

5. The computer-implemented method according to claim 1, wherein
the user-consumption-pattern-determination-algorithm is trained on history data or data collection representing amount of cumulative heat tapped from the heat storage tank by a user or a household over a second time period, and
hour of day of the respective first time period within the respective history or data collection of data representing amount of cumulative heat tapped.

6. The computer-implemented method according to claim 4, wherein
the second time period extends over 30 days, 60 days, 90 days, 180 days, one year or two years.

7. The computer-implemented method according to claim 4, wherein
the user-consumption-pattern-determination-algorithm is further trained on at least one of
day of week of at least one of the respective first time period and the respective history or data collection of data representing amount of cumulative heat tapped,
at least one of day of the year, week of the year, and month of the year of at least one of the respective first time period and the respective history data or data collection,
weather condition at at least one of the respective first time period and the respective history or data collection of data representing amount of cumulative heat tapped,
outside temperature at at least one of the respective first time period and the respective history or data collection of data representing amount of cumulative heat tapped,
vacation situation of the user or the household at at least one of the respective first time period and the respective history or data collection of data representing amount of cumulative heat tapped,
energy price at at least one of the respective first time period and the respective history or data collection of data representing amount of cumulative heat tapped,
green energy availability at at least one of the respective first time period and the respective history or data collection of data representing amount of cumulative heat tapped,
geographical location at at least one of the respective first time period and the respective history or data collection of data representing amount of cumulative heat tapped, and
cultural factors at at least one of the respective first time period and the respective history or data collection of data representing amount of cumulative heat tapped.

8. The computer-implemented method according to claim 1, wherein
the user-consumption-pattern-determination-algorithm also considers at least one meta data when determining the user consumption pattern, and the at least one meta data is selected from the group consisting of:
number of residents,
age(s) of the resident(s),
average age of the residents,
gender of the resident(s),
geographical location,
cultural factors, and
annual hot water consumption.

9. The computer-implemented method according to claim 8, wherein
the user-consumption-pattern-determination-algorithm further includes:
assigning the user or household to a predetermined cluster or group based on at least one of the meta data, and
determining a user-consumption-pattern-determination-sub-algorithm based on the assigned cluster or group,
wherein the user-consumption-pattern-determination-sub-algorithm being was preferably trained on the data of a plurality of users or households having the same at least one of the meta data.

10. The computer-implemented method according to claim 9, wherein
after a user-consumption-pattern-determination-sub-algorithm is determined, an individual-user-consumption-pattern-determination-algorithm is developed by training a pre-set user-consumption-pattern-determination-sub-algorithm based on at least one of
acquired first history data or data collection(s) and
acquired second history (H₂) data or data collection(s) representing amount of cumulative heat tapped by the user or the household over a third time period,
the third timer period extending over 1 day, 2 days, 10 days, 30 days, 60 days, 90 days, 180 days, one year or continuously.

11. The computer-implemented method according to claim 1, wherein
the user-consumption-pattern-determination-algorithm is trained to determine habits of individual users including taking shower in the morning, taking shower in the evening, taking bath in the evening, using an average amount of cumulative heat, which is an amount of equivalent energy, for taking a shower or a bath.

12. A computer-implemented method of generating a domestic hot water consumption forecast, the method comprising:
acquiring a user consumption pattern of domestic hot water by using the computer-implemented method according to claim 1; and
generating the domestic hot water consumption forecast by applying a domestic-hot-water-consumption-forecast-algorithm to the acquired user consumption pattern.

13. The computer-implemented method according to claim 12, wherein
the domestic-hot-water-consumption-forecast-algorithm considers detected deviations when generating the domestic hot water consumption forecast, and
the deviations include vacation situation of the user or the household, weather condition, and unexpected events.

14. The computer-implemented method according to claim 13, wherein
in the event of a detection of a deviation, at least one of
the domestic hot water consumption forecast is automatically adjusted and
the user is required to confirm the detected deviation via a control terminal, and depending on at least one of the confirmation and input of the user, the domestic hot water consumption forecast is adjusted.

15. The computer-implemented method according to claim 12, wherein
the domestic hot water consumption forecast is determined for a fourth time period of 10 minutes, 30 minutes, 1 hour, 2 hours, 4 hours, 6 hours or 12 hours.

16. The computer-implemented method according to claim 13, wherein
events including vacation of the user or household, guest(s), and party, are determined at least one of
by accessing online data like calendar and
by input of the user via a remote control terminal.

17. A computer-implemented method of controlling at least one of domestic hot water production and distribution by controlling a system for at least one of producing and distributing domestic hot water, the method comprising:
generating a domestic hot water consumption forecast by using the computer-implemented method according to claim 12, and
controlling at least one of domestic hot water production and distribution based on the generated domestic hot water consumption forecast.

18. The computer-implemented method according to claim 17, wherein
an amount of heat over a control period to be stored in the heat storage tank is determined based on the generated domestic hot water consumption forecast.

19. The computer-implemented method according to claim 17, wherein
an amount of heat over a control period to be stored in the heat storage tank is determined by applying a heat-control-algorithm to the generated domestic hot water consumption forecast, and the heat-control-algorithm is a trained algorithm.

20. The computer-implemented method according to claim 19, wherein
the heat-control-algorithm is trained on at least one of electric energy price, local or green energy availability, weather condition, energy carbon footprint, and weather forecast.

21. A controller for generating a domestic hot water consumption forecast, the controller comprising:
a control unit configured to execute the method according to claim 12.

22. A controller for controlling at least one of domestic hot water production and distribution by controlling a system for at least one of producing and distributing domestic hot water, the controller comprising:
a control unit configured to execute the method according to claim 17.

23. A system for at least one of producing and distributing domestic hot water, the system comprising:
the controller according to claim 21, the controller being configured to
generate a domestic hot water consumption forecast by using the computer-implemented method, and
control at least one of domestic hot water production and distribution based on the generated domestic hot water consumption forecast.

24. The system (100) according to claim 23, further comprising:
a hot water storage tank, the hot water storage tank being a pressurized tank,
the controller being configured to at least one of
determine an amount of equivalent energy, stored in the hot water storage tank and
determine an amount of equivalent energy, tapped from the hot water storage tank.

25. A computer program comprising:
instructions to cause the system of claim 23 to
generate a domestic hot water consumption forecast by using the computer-implemented method, and
control at least one of domestic hot water production and distribution based on the generated domestic hot water consumption forecast.

26. A computer-readable medium having stored thereon the computer program of claim 25.
